(19) United States
(12) Patent Application Publication
(10) Pub. No.: US 2010/0236712 A1
(43) Pub. Date: Sep. 23, 2010

(54) FULLY AUTOMATIC RFID LABELER

(76) Inventors: Thomas Michael Basgil, Cinnaminson, NJ (US); Thomas Pituch, Sarasola, FL (US)

Correspondence Address: Donald C. Simpson, 126 Borton Landing Road, Moorestown, NJ, 08057-3055, US

(21) Appl. No.: 12/406,111

(22) Filed: Mar. 18, 2009

(51) Int. Cl. B32B 37/00

(52) U.S. Cl. 156/324; 156/538

(57) ABSTRACT

An apparatus and method for the fully automated application of RFID tags which are applied to the adhesive side of a pressure sensitive label with 100% verification and inspection and where any rejection occurs prior to the application of the label to a container.

### CROSS-REFERENCE TO RELATED APPLICATIONS

Not applicable.

### FEDERALLY SPONSORED RESEARCH AND DEVELOPMENT

Not applicable.

### FIELD OF THE INVENTION

Apparatus and method for automatic RFID labeling.

### BACKGROUND OF THE INVENTION

Serialization, i.e., the assignment of serial identification numbers to individual product items, has become a necessity in the pharmaceutical, generic, biological, food and beverage industries as a result of label counterfeiting, diversion of products, and theft. Many pharmaceutical companies are turning to serialization of products with a 2-D data matrix code, i.e. a two-dimensional matrix bar code consisting of black and white square modules arranged in either a square or rectangular pattern. The information to be encoded can be text or raw data. Usual data size is from a few bytes up to 2 kilobytes. The length of the encoded data depends on the symbol dimension used. The food industry frequently uses a YottaMark code , i.e., an integrated system for validating products throughout the supply chain based on security codes marked on products or packaging for unit level authentication. Products with YottaMark security codes can be verified with a camera phone, hand-held scanner, or the Internet. Each of these codes carries a unique serialized code containing the individual item level component. This provides a mechanism for supply chain partners to access the serial number to verify that the product they are receiving is authentic and that they received all the products destined for them.

The problem with such serialized codes is that they cannot be tracked and traced as easily as RFID tags. RFID (Radio Frequency Identification) is a superior, albeit, a more expensive means of identifying objects via radio frequency transmission. The most common frequencies used are High (HF) and Ultra High (UHF). A typical RFID system comprises a tag, a reader and a host system. The tag comprises a combination of an antenna and a programmable RFID chip adapted to receive the desired serial numbers, commonly referred to as an inlay. The reader comprises an antenna adapted to receive the serial numbers from a programmed tag. The host is typically a computer adapted to decipher the information received by the reader. The host manages the information flow, sending and receiving information to and from the reader and the tags. In order to apply the tags to each individual container in order to track and trace the product, presently the label supplier must marry the RFID tags and pressure sensitive labels. The label supplier purchases the RFID tags in a pressure sensitive format. The tags are then applied to the adhesive side of the label. There are varying methodologies for this process, but the end result is high cost inventory controls and potential waste to the end users. These tags are 100% inspected at the label supplier and are very costly. Many manufacturers are looking for alternative solutions to RFID tagged labels due to their very high cost.

It's very easy to read the RFID tags that are already on each unit component to ensure the cartons are complete. The cartons then receive a RFID label corresponding to the components in the case which give the cases a parent/child relationship. The cases are then put onto a pallet, which receives another RFID tag, giving the pallet, carton, and unit components a parent/child relationship that can be tracked and traced throughout the entire delivery chain.

Present RFID applicator technology cannot apply “tag inlays” at production speeds, so manufacturers are utilizing RFID tags that are already adhered to a pressure sensitive label. These RFID tag inlays are applied to the pressure sensitive labels at the label converter which is a very costly process and, due to the present pricing structure, many companies are avoiding RFID technology.

### SUMMARY OF THE INVENTION

The present invention provides a process for applying just the tag inlays at production speeds to the item level containers. This process and methodology provides major advantages from a cost and inventory perspective to the manufacturers of pharmaceuticals, generics, biological, food, and beverage products. The RFID tag is written on-line in a continuous motion format. Presently, only RFID tags are written to and applied to pallets and cases on a production floor environment in an intermittent format. The present invention permits use of a continuous motion tag applicator that applies the tag inlay to a vacuum drum which then applies the tag to an item level container. The “continuous motion process” allows the RFID antenna the entire cycle time to download the information to the RFID tag. The vacuum drum velocity matches the item level container that is traveling past the application point. The RFID tag inlay applicator runs at a much slower velocity which allows utilization of the entire cycle time to write to the tag inlay.

After the tag is applied to the unit dose container, a pressure sensitive label maybe applied over the tag if the manufacturer deems it necessary. This label may have a printed data matrix code that corresponds to the RFID tag, e.g. the same information will be printed in the data matrix code as the RFID tag.

This new design eliminates the label converter and substantially lowers the cost of applying RFID tagged labels in the manufacturing process. The present invention comprises a high speed, fully automatic process to program the RFID tags, marry the tags to a pressure sensitive label utilizing a servo motor driven vacuum drum and then applying the programmed RFID tag and label to the container. The tags and labels are 100% verified for correctness and any faulty tags or labels are reconciled onto a paper or Mylar substrate prior to the application point. This eliminates the costly rework of containers that have faulty tags and or labels. Present tag writing technology also has speed limitations. To overcome this problem, this invention utilizes multiple writers in tandem and the tags are indexed by a servo drive system in multiples depending on the desired speed. This greatly enhances the speed capability, resulting in the ability to run at normal production speeds.

As an alternative to the above system, further technology is now available to write to an RFID tag in motion without ever stopping the tag, a preferred embodiment. This design moves the tag inlay in a continuous motion format, allowing the machine to write to the tag during the entire cycle time of the container. The servo-driven vacuum drum allows the RFID tag inlay (antenna and chip) high-speed applicator to run at a much slower velocity than the vacuum drum. A servo motor is an intelligent motor that, with an encoder feeding back information to the motor, is able to adjust its speed according to the main machine speed. The vacuum drum needs to match the linear or circumferential speed of the container as it passes the application point. The RFID tag inlay high speed applicator is provided with an encoder mounted to the drive system that follows the servo motor that is on the vacuum drum. The drive system matches the vacuum drum rotational velocity at a predetermined slower speed. The speed is determined by the unit dose containers per minute. For instance, if the speed of the line is 300 containers per minute, there will be 200 milliseconds of time to write to the tag. If the tag inlay is 2 inches long, the linear velocity (speed) of the tag is only 600 inches/min. but the drum speed on the machine would need to be 1500 inches/min due to the unit dose container pitch which is 5 inches. “Pitch” is defined herein as the distance from the lead edge of one container to the lead edge of the next container. These velocities change based on the unit dose container line speed and the machine pitch. However, it is preferred to run the RFID tag inlay applicator as slowly as possible to get the maximum tag writing time available. As can be seen from the above, there are several options available to the labeling industry for practicing the present invention.

### BRIEF DESCRIPTION OF THE DRAWINGS

FIG. 1 is a layout of the basic equipment of the present invention identified y as Option A.

FIG. 2 is a blow up of a critical section of FIG. 1.

FIG. 3 is a layout of a preferred embodiment of the present invention identified as Option B.

FIG. 4 is a blow up of a critical section of FIG. 3.

FIG. 5 is a layout of another embodiment of the present invention identified as Option C.

FIG. 6 is a blow up of a critical section of FIG. 5.

FIG. 7 is a layout of Option D, the most preferred embodiment of the present invention.

FIG. 8 is a blow up of a critical section of FIG. 7.

### DESCRIPTION OF THE PREFERRED EMBODIMENTS

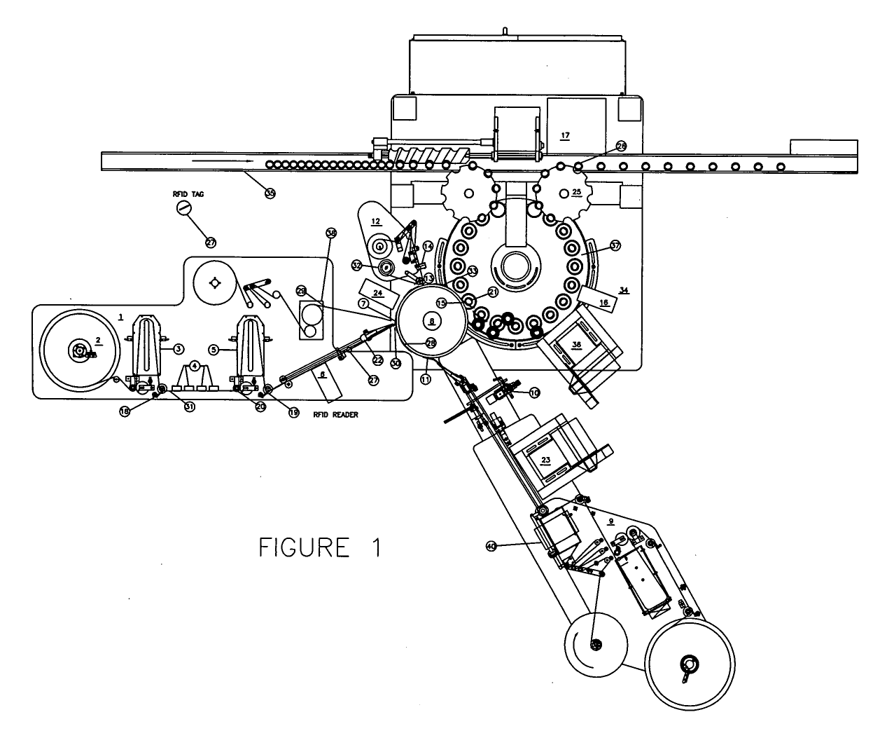

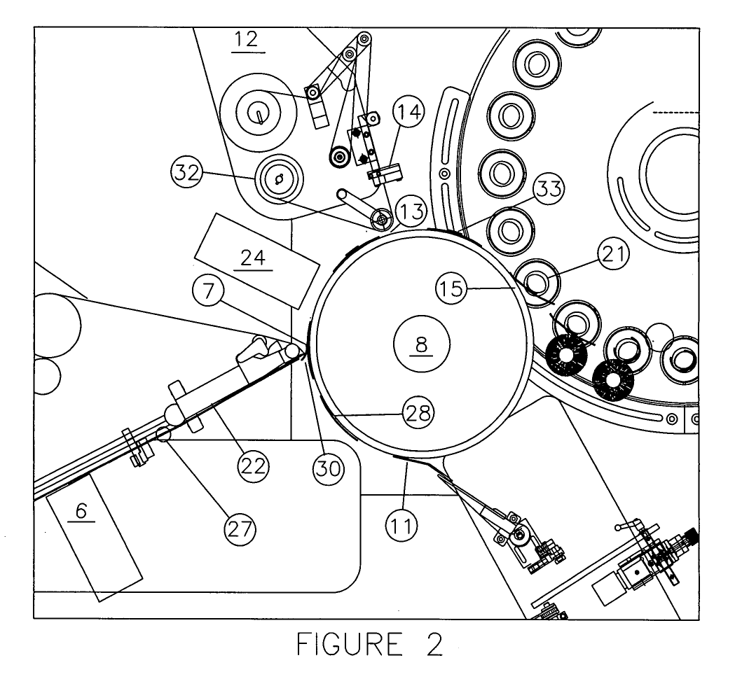

### Option A—FIG. 1 and FIG. 2

FIG. 1 is a general layout of the equipment used in the present invention. FIG. 2 is a blow-up of a portion of FIG. 1 for ease of reading.

### Description of Numbered Components

1. RFID tag applicator
2. 18″ Supply spool for tags
3. Vacuum unwind loop box
4. RFID writers
5. Second Vacuum unwind loop box
6. RFID tag antenna
7. Tag application point
8. Vacuum Drum
9. Pressure Sensitive Label Head
10. Vision Camera
11. Pressure Sensitive Label Head application point
12. Reconciliation unit
13. Reconciliation unit label/tag pick off point
14. Pick off verification sensor
15. Label Application point
16. RFID tag antenna
17. Reject Blow off area with verification
18. Hold back shoe
19. Second hold back shoe
20. Servo driven unwind roller
21. Container at application point
22. Interceptor—Retractable peel plate
23. Laser or printer—Prints data matrix, lot, exp etc.
24. Second RFID tag antenna
25. Exit starwheel
26. Finished container
27. RFID Tag
28. Pressure Sensitive Label
29. Release Liner
30. RFID Peel Plate
31. Tag Web
32. Paper or Mylar Substrate
33. RFID/Tag Label
34. Rotary Labeler System
35. Conveyor
36. Optional Printer
37. Rotary Dial

### Operation of Option A

RFID applicator #1 and a pressure sensitive label applicator #9 are positioned inline with a vacuum drum transfer unit #8. Item #9 contains the pressure sensitive labels and Item #1 contains the RFID tags. On Item #1 the RFID applicator, an unwind spool #2 is utilized to hold the RFID tags. These tags can be pre-programmed or blank tags. The tags are threaded into a vacuum unwind loop box #3 to ensure a constant pressure to the tag web #31 regardless of the inertia changes from a large to small roll of tags. A pressure shoe #18 applies a small hold back force on the web to create a flat web for the RFID antenna #4. The RFID antenna #4 will program blank tags #27 with the correct manufacturer's information. The servo motor driven unwind roller #20 will feed “X” distance based on the number of antennas required. The driven roller #20 will feed the programmed tags #27 into another vacuum unwind loop box #5. The loop box is designed to hold enough tags #27 to ensure that the web can keep up with the line speed requirements. A second hold back shoe #19 creates a small amount of tension to control the web to the peel plate #30. An RFID tag antenna #6 inspects each tag #27 for the correct information. If the tag is satisfactory, the printer #23 on the label head #9 or optional printer #36 on the rotary labeler system #34 will print a data matrix code or various information on the pressure sensitive label to match the RFID tag's information. If the tag is deemed bad, the peel plate interceptor #22 will keep the bad RFID tag on the release liner #29. The tag will go around the peel plate and stay on the liner #29 and the corresponding label #28 will be intercepted by the Reconciler #12. Another tag #27will be indexed into position for the next label #28. The tag #27 will be married to the label #28 at position #7. After the tag #27 is applied to the label #28, a second RFID tag inspection #24 is performed. If the tag is deemed bad, a reconciler unit #12 will pick off the bad tag/label from the vacuum drum #8 at position #13 and apply it to a paper substrate #32. The reconciler #12 has a rejected label verification sensor #14 to ensure that the label was picked off the vacuum drum #8 and applied to the transfer paper substrate #32. The container #21 that was supposed to receive this label is rejected into the reject bin #17. After the RFID tag/label #33 is applied to the container #21, a third RFID tag reader #16 again inspects and verifies that the tag and label are correct. If an incorrect label/tag is detected, the labeler system #34 tracks the bad container on the rotary dial #37 and rejects the container into the reject bin #17. All good containers #26 exiting the star-wheel #25 travel down the conveyor #35 to the next packaging machine.

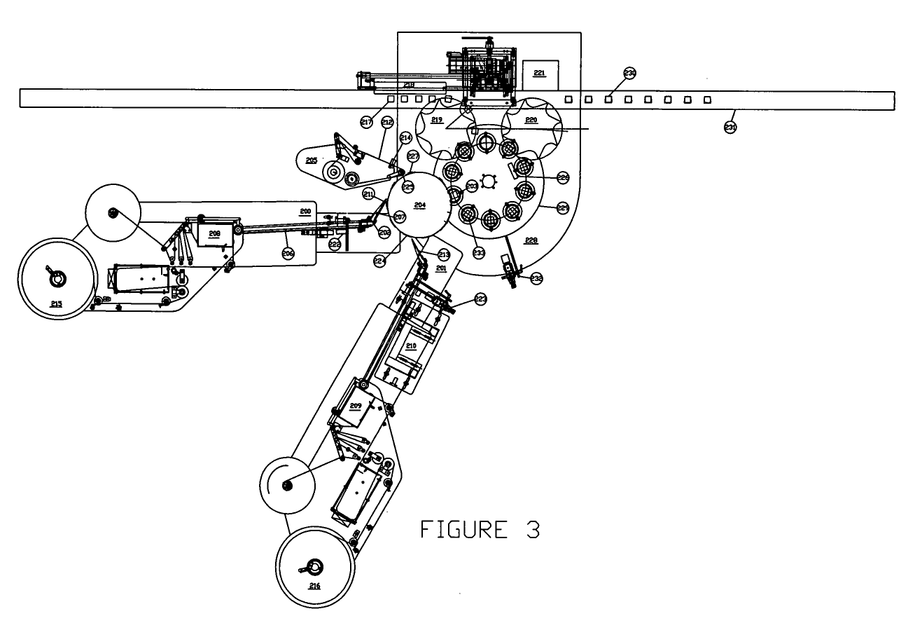

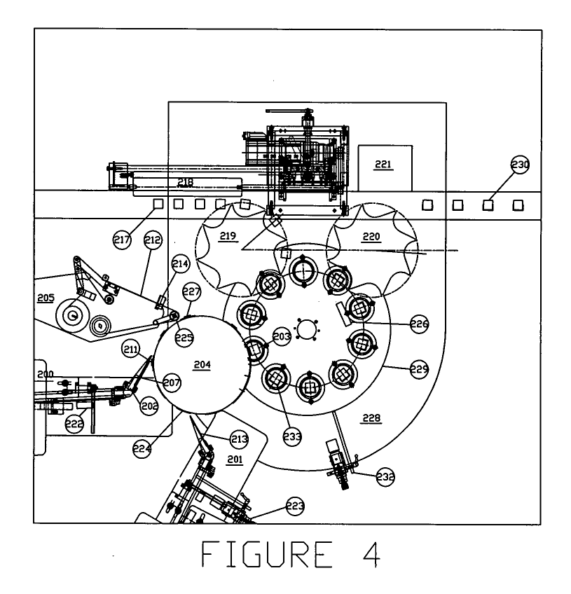

### Option B—FIG. 3 and FIG. 4

### Description of Numbered Components

200—RFID applicator to apply the RFID tag inlays
201—Standard rotary labeler applicator to apply the pressure sensitive labels
202—RFID peel plate
203—Application point of the RFID tag/label
204—Vacuum drum for the RFID tag inlay and pressure sensitive label
205—Reconciliation unit for the RFID tag inlay and pressure sensitive label
206—Pressure sensitive RFIG tag carrier
207—RFID tags
208—Servo motor with encoder mounted to the push/pull RFID tag
209—Servo motor with encoder mounted to the push/pull Pressure sensitive labeler
210—Laser or printer for the pressure sensitive labeler
211—RFID tag inlay on the vaccum drum.
212—Mylar web on the reconciliation unit.
213—Pressure sensitive labeler peel plate
215—18″ unwind for the RFID tag inlays.
216—18″ unwind for the pressure sensitive labels.
217—Unit dose containers
218—Feed screw
219—Infeed star wheel
220—Outfeed star wheel
221—Reject bin
222—RFID antenna
223—Camera for verifications of codes on the pressure sensitive labeler
224—Label on drum
225—Label/tag pick off position
226—Commissioning RFID antenna
227—Tag and label unit
228—Labeler system
229—Rotary dial
230—Good unit dose container
231—Conveyor
232—Turret camera inspection
233—Container with tag/label on turret

### Operation of Option B

RFID applicator #200 and a standard pressure sensitive label applicator #201 are positioned in line with the vacuum drum #204. Servo motors with encoders #208 and #209 are synchronized with the vacuum drum #204, allowing the RFID tag inlay applicator #200 and the pressure sensitive label applicator #201 to run at in sync velocity to the drum #204. Both Applicator #200 and Applicator #201 will run at different velocities based on the length of the tag or label. The drum is in sync with the velocity of the item level dose containers. Item #201 contains the pressure sensitive labels and item #200 contains the RFID tags. On item #200, the RFID applicator, an unwind spool #215 is utilized to hold the RFID tags #202. These tags are blank inlays on a pressure sensitive liner item #206. The RFID antenna #222 will program blank tags #202 with the correct manufacturer's information. The programming is accomplished on the fly via the RFID antenna #222 in a continuous motion format. The printer #210 on the pressure sensitive applicator #201 prints a data matrix code or various information on the pressure sensitive label to match the RFID tag's #202 information. If the RFID tag #202 is deemed bad via the RFID antenna #222, a reconciler unit #205 will pick off the bad tag/label unit #227 from the vacuum drum #204 at position #225 and apply it to a paper or Mylar substrate #212. The reconciler #205 has a rejected label verification sensor #214 to ensure that the label was picked off the vacuum drum #204 and applied to the transfer paper or Mylar substrate #212. The container #217 will not receive a tag and label #227 at the application point #203. A camera #232 will verify a missing label and the RFID commissioning antenna #226 will verify a missing tag and the unit dose container will be rejected into the reject blow off bin #221. All good tag/label containers #233 will be inspected on the turret Vision camera #232 for the label and a RFID tag antenna #226 to verify that the tag is correct. If an incorrect tag/label #227 is detected, the labeler system #228 will track the bad container on the rotary dial #229 and reject the container into the reject bin #221. All good unit dose containers #230 exiting the star-wheel #220 will travel down the conveyor #231 to the next packaging machine. The combination of the vacuum drum #204, the pressure sensitive label encoder #209 and the RFID applicator encoder #208 enables the tag applicator #200 and labeler #201 to run in continuous motion at high production speeds.

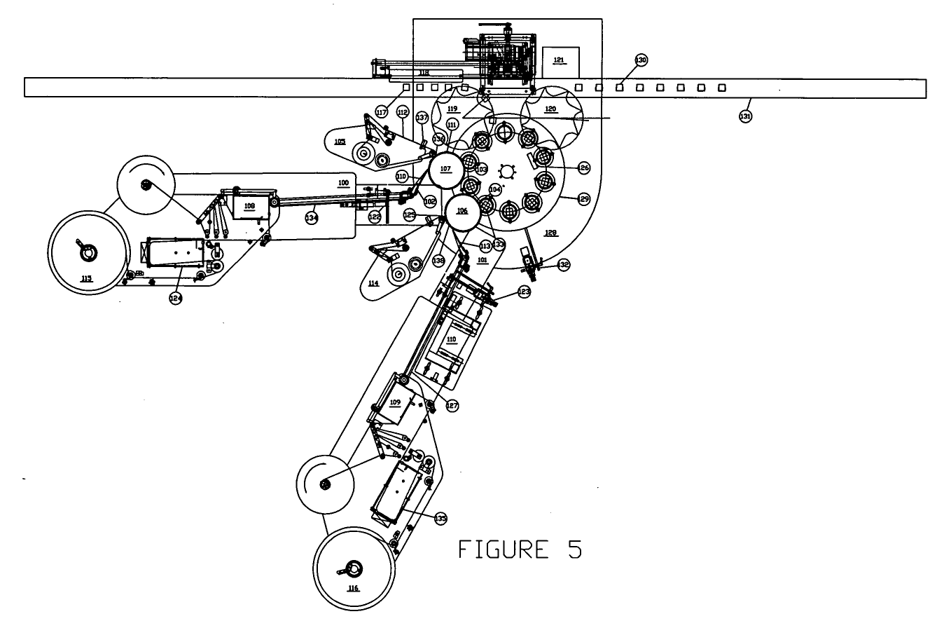

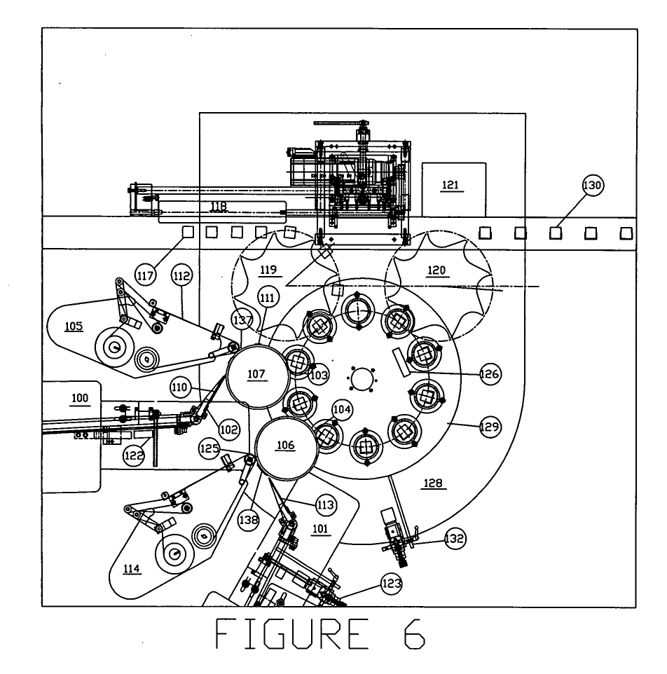

### Option C—FIG. 5 and FIG. 6

### Description of Numbered Components

100—RFID applicator to apply the RFID tag inlays
101—Standard rotary labeler applicator to apply the pressure sensitive labels
102—RFID tag inlays
103—Application point of the RFID tag inlay
104—Application point of the pressure sensitive label
105—Reconciliation unit for the RFID tag inlay
106—Vacuum drum for the pressure sensitive labeler
107—Vacuum drum for the RFID tag inlay
108—Servo motor with encoder mounted to the push/pull RFID applicator
109—Servo motor with encoder mounted to the push/pull pressure sensitive label applicator
110—RFID peel plate
111—RFID tag inlay on the vaccum drum.
112—Mylar web on the reconciliation unit.
113—Pressure sensitive labeler peel plate
114—Reconciliation unit for the pressure sensitive label
115—18″ unwind for the RFID tag inlays.
116—18″ unwind for the pressure sensitive labels.
117—Unit dose containers
118—Feedscrew
119—Infeed star wheel
120—Outfeed star wheel
121—Reject bin
122—RFID antenna
123—Camera for verifications of codes
124—RFID application unwind box
125—Label pick off position
126—Commissioning RFID antenna
127—Pressure Sensitive label liner
128—Labeler system
129—Rotary dial
130—Good unit dose container
131—Conveyor
132—Turret camera inspection
133—Container with tag/label on turret
134—Pressure sensitive tag liner
135—Pressure sensitive unwind box
136—RFID tag pick off point
137—Label sensor
138—Pressure sensitive label
139—Verification sensor for Pressure sensitive reconciler

### Operation of Option C

RFID applicator #100 and a standard pressure sensitive label applicator #101 are positioned in line with separate vacuum drums, RFID drum #107 and pressure sensitive vacuum drum #106. Servo motors with encoders #108 and #109 are synchronized with the servo motor vacuum drum allowing the RFID tag inlay applicator #100 and the pressure sensitive label applicator #101 to run at in sync velocity to their drums #106 and #107. Both applicator #100 and applicator #101 will run at different velocities based on the length of the tag or label. The vacuums drums will be in sync with the circumferential velocity of the item level dose containers #117. Item #101 contains the pressure sensitive labels #138 and item #100 contains the RFID tags #102. On item #100, the RFID applicator, an unwind spool #115 is utilized to hold the RFID tags #102. The tags #102 are threaded into a vacuum unwind loop box #124 to ensure a constant pressure to the tag web #134 regardless of the inertia changes from a large to small roll of tags. The RFID antenna #122 will program blank tags #102 with the correct manufacturer's information. The programming is accomplished on the fly via the RFID antenna #122 in a continuous motion format. The pressure sensitive liner #127 is threaded into a vacuum unwind loop box #135 to ensure a constant pressure to the label #127 regardless of the inertia changes from a large to small roll of labels. The printer #110 on the pressure sensitive applicator #101, which also runs the pressure sensitive liner #127 in the continuous motion format, will print a data matrix code or various information on the pressure sensitive label to match the RFID tags #102 information. If the RFID tag #102 is deemed bad via the RFID antenna #122, a reconciler unit #105 will pick off the bad tag #102 from the vacuum drum #107 at position #136 and apply it to a paper or Mylar substrate #112. The reconciler #105 has a rejected tag verification sensor #137 to ensure that the tag was picked off the vacuum drum #107 and applied to the transfer paper or Mylar substrate #112. At the same time the corresponding label #138 will be picked off the vacuum drum #106 at pick off point #125 by the reconciler unit #114. The reconciler unit #114 also has a rejected label verification sensor #139. The container#117 will not receive a tag #102 or label #138 at the application point #103 or #104. The Vision camera #132 will verify a missing label and the RFID commissioning antenna #126 will verify a missing tag and the unit dose container #117 will be rejected into the reject blow off bin #121. All good tag/labels containers #133 will be inspected on the turret Vision camera #132 for the label and a RFID tag antenna #126 to verify if the tag is correct. If an incorrect tag/label #111 is detected, the labeler system #128 will track the bad container on the rotary dial #129 and reject the container into the reject bin #121. All good unit dose containers #130 exiting the star-wheel #120 will travel down the conveyor #131 to the next packaging machine. This continuous mode of operation enables the tag applicator #100 and labeler #101 to run at higher speeds due to the vacuum drums #106 and #107 which have to match the unit dose container velocity, while the RFID applicator#100 and the pressure sensitive labeler #101 can run at much slower velocities to enable the RFID tag writing and the pressure sensitive label information printing.

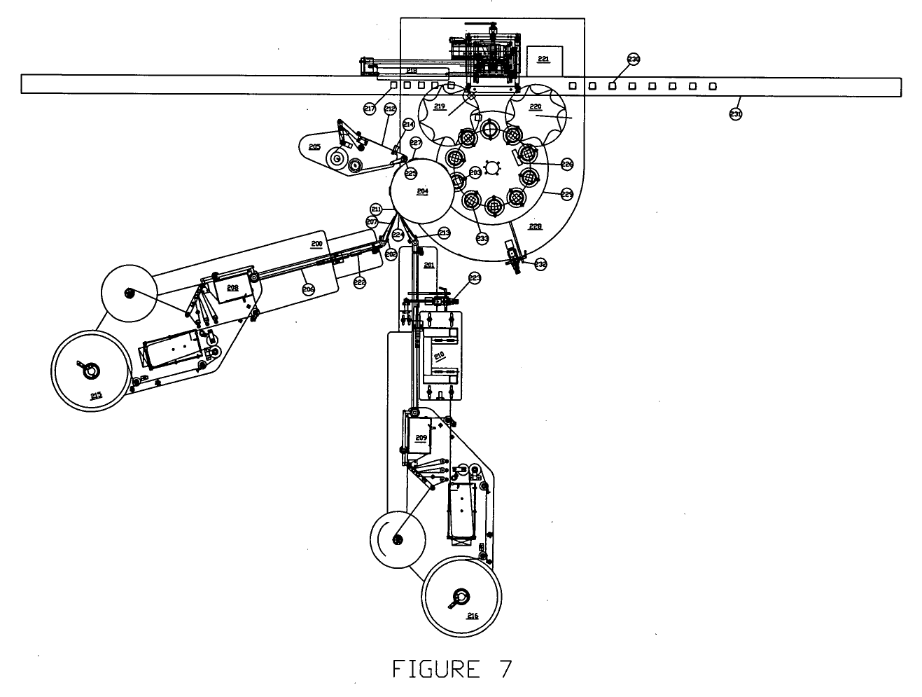

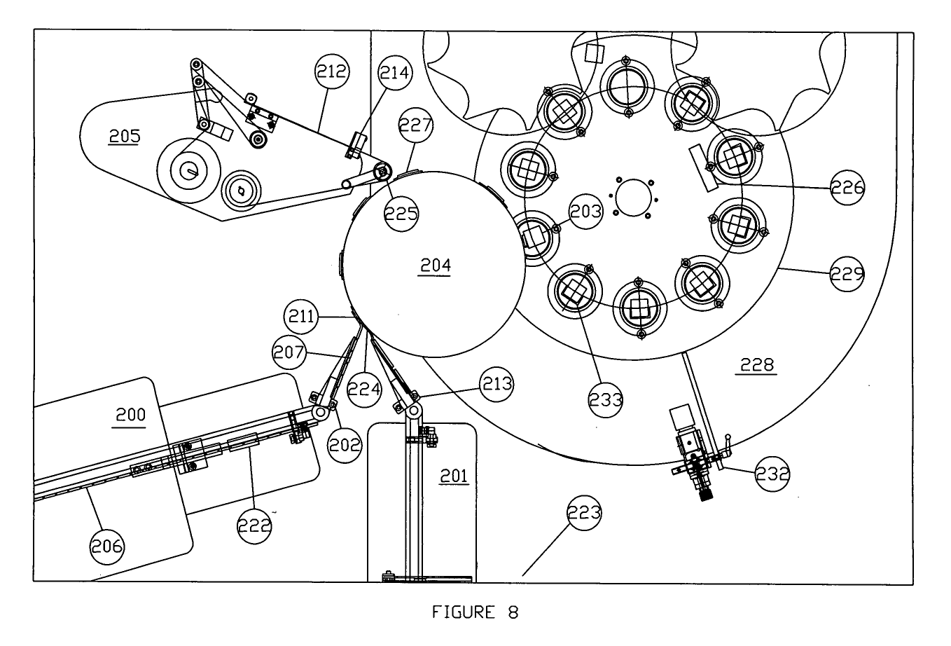

### Option D—FIG. 7 and FIG. 8

### Description of Numbered Components

### See Description of Numbered Components for Option B.

### Operation of Option D

This option permits the RFID tag and the label to match velocity while the drum is going at a substantially higher velocity. As a result, the marriage of the RFID tag to the label proceeds much more smoothly. It is illustrated in FIGS. 7 and 8 as a modification of Option B.

RFID applicator #200 and a standard pressure sensitive label applicator #201 are positioned inline the vacuum drum #204. The servo motors with encoders #208 and #209 are synchronized with the vacuum drum #204 allowing the RFID tag inlay applicator #200 and the pressure sensitive label applicator #201 to run slower than sync velocity to the drum #204. Both applicator #200 and applicator #201 will run at different velocities based on the length of the tag or label. The drum will be in sync with the velocity of the item level dose containers. This Option “D” configuration allows pressure sensitive label and RFID tag inlay to be applied to the vacuum drum simultaneously. Item #201 contains the pressure sensitive labels and item #200 contains the RFID tags. On item #200 the RFID applicator, an unwind spool #215 is utilized to hold the RFID tags #202. These tags are blank inlays on a pressure sensitive liner item #206. The RFID antenna #222 will program blank tags #202 with the correct manufacturer's information. The programming is accomplished on the fly via the RFID antenna #222 in a continuous motion format. The printer #210 on the pressure sensitive applicator #201 will print a data matrix code or various information on the pressure sensitive label to match the RFID tags #202 information. If the RFID tag #202 is deemed bad via the RFID antenna #222, a reconcile unit #205 will pick off the bad tag/label unit #227 from the vacuum drum #204 at position #225 and applied it to a paper or Mylar substrate #212. The reconcile #205 has a rejected label verification sensor #214 to ensure that the label was picked off the vacuum drum #204 and applied to the transfer paper or mylar substrate #212. The container #217 will not receive a tag and label #227 at the application point #203. A camera #232 will verify a missing label and the RFID commissioning antenna #226 will verify a missing tag and the unit dose container will be rejected into the reject blow off bin #221.

All good tag/labels containers #233 will be inspected on the turret Vision camera #232 for the label and a RFID tag antenna #226 to verify if the tag is correct. If an incorrect tag/label #227 is detected, the labeler system #228 will track the bad container on the rotary dial #229 and reject the container into the reject bin #221. All good unit dose containers #230 exiting the star-wheel #220 will travel down the conveyor #231 to the next packaging machine. The vacuum drum #204, the pressure sensitive label encoder #209 and the RFID applicator encoder #208 enables the tag applicator #200 and labeler #201 to run in continuous motion at high production speeds.

In summary, the present invention provides fully automated application of RFID tags applied to the adhesive side of the pressure sensitive label with 100% verification and inspection with rejection prior to the application of label to the container. This eliminates reworking of containers with incorrect or bad tags or labels. It should never be expected that a bad tag or label will be applied to a container. This invention also provides high speed tag writing. Multiple RFID writers can be in line with the RFID tags to program them at production speeds. While the tags are usually indexed in multiples after they are programmed, preprogrammed tags may also be used with this system. It is preferred, however, to program the tags online. Again, as a preferred alternative, a packager can run the RFID tag inlays in a continuous motion format as explained above.

What is claimed is:

1. A fully automatic RFID labeler substantially as described and shown.

2. An RFID labeler in accordance with claim 1 comprising Option A.

3. An RFID labeler in accordance with claim 1 comprising Option B.

4. An RFID labeler in accordance with claim 1 comprising Option C.

5. An RFID labeler in accordance with claim 1 comprising Option D.

6. A method for applying RFID for the automatic labeling of containers at high speed substantially as described and shown.

7. A method in accordance with claim 6 comprising the use of the Option A RFID labeler.

8. A method in accordance with claim 6 comprising the use of the Option B RFID labeler.

9. A method in accordance with claim 6 comprising the use of the Option C RFID labeler.

10. A method in accordance with claim 6 comprising the use of the Option D RFID labeler.
